(19) United States
(12) Patent Application Publication
(10) Pub. No.: US 2010/0268490 A1
(43) Pub. Date: Oct. 21, 2010

(54) LIQUID MEASUREMENT SYSTEM AND METHOD THEREOF

(75) Inventor: Ken-Chih Chang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: YOUNG GREEN ENERGY CO., HSINCHU COUNTY (TW)

(21) Appl. No.: 12/631,807

(22) Filed: Dec. 5, 2009

(30) Foreign Application Priority Data
Apr. 21, 2009 (TW) 98113189

(51) Int. Cl. G01F 23/26

(52) U.S. Cl. 702/55

(57) ABSTRACT

A liquid measurement system detects a surplus status of a liquid fuel in a fuel cell. The liquid measurement system includes a storage device, two electrodes, a charging and discharging circuit, and a processing unit. The storage device has a containing space for storing the liquid fuel and disposed between the electrodes. The electrodes are oppositely disposed on the outer surface of the storage device to form a capacitor. The charging and discharging circuit is electrically connected to the electrodes to cyclically charge/discharge the capacitor between a first voltage and a second voltage to generate an output signal. The processing unit is electrically connected to the charging and discharging circuit to receive the output signal and obtains a wave number of the output signal within a specific time interval to determine the surplus status of the liquid fuel in the containing space.

### CROSS-REFERENCE TO RELATED APPLICATION

This application claims the priority benefit of Taiwan application serial No. 98113189, filed on Apr. 21, 2009. The entirety of the above-mentioned patent application is hereby incorporated by reference herein and made a part of this specification.

### BACKGROUND OF THE INVENTION

1. Field of the Invention

The present invention relates to a liquid measurement system and a method thereof, and particularly to a liquid measurement system and a method thereof adapted to a fuel cell.

2. Description of Related Art

U.S. Pat. No. 7,370,528 discloses a resistance level gauge and immerses two metallic electrodes in a liquid fuel to detect an equivalent resistance of the liquid fuel between the two metallic electrodes. The equivalent resistance of the liquid fuel varies with the level of liquid fuel and causes the time that an inner capacitor is charged to a given voltage be varied with the level of the liquid fuel. Besides, a control unit determines the level of the liquid fuel according to the charging time.

R.O.C patent No. M331106 discloses a capacitive level gauge and puts the level gauge in a liquid fuel, wherein the inner body of the level gauge includes a plurality of strip lines extending along the side direction. The strip lines are interlaced with each other to form a capacitance effect. When the level of the liquid fuel is changed, the capacitance sensed by the level gauge varies with the level of the liquid fuel, and the level gauge determines the level of the liquid fuel according to the sensed capacitance.

R.O.C. patent No. M307199 discloses a capacitive level gauge. The R.O.C. patent No. M307199 disposes two parallel metallic plates in a fuel tank to be an electrode and uses a solution in the fuel tank to be a dielectric layer so as to form a capacitor. Then, the amount of the fuel in the fuel tank is determined according to the capacitance of the capacitor. In addition, R.O.C. patent No. 563136 and No. 1284494 disclose a plurality of comparators and a circuit diagram of a charging device of a latch.

Based on the above, the level gauges of the conventional technology have at least one of the following disadvantages.

Disposing the metallic electrodes or the metallic plates in the liquid fuel causes the metallic electrodes or the metallic plates be corroded and hence affects the electric measurement, or pollutes the liquid fuel that causes malfunction of the fuel cell result from an abnormal chemical reaction.

Since the electrode plates of the level gauge or the strip lines are directly contacted with the liquid fuel in the conventional level gauge, the capacitance of the level gauge varies when the storing device is slanted and hence results in an overestimation or an underestimation of the level of the liquid fuel.

The U.S. Pat. No. 7,370,528 has about 10% to 30% error between two level gauges with the same specification and the same process. Hence, the coincidence of the level measure of the level gauges produced under the same specification is very low.

In the R.O.C. patent No. M307199, the fuel tank has a large capacitance and due to the wiring way of the wires between the defective capacitor and the control unit, a significant parasitic capacitance exists between the wires. Hence, the most capacitance sensed by the control unit is the capacitance of the fuel tank and the above-mentioned parasitic capacitance, so that the degree of the effect that the amount of the liquid fuel influences the capacitance sensed by the control unit is limited. As a result, the precision of the measurement is low and the level gauges of the conventional technology are hard to be applied to an application that accurately controlling level is needed.

### SUMMARY OF THE INVENTION

The present invention provides a liquid measurement system which precisely detects a surplus status of a liquid fuel in a fuel cell so as to prevent electrodes from being corroded by the liquid fuel.

The present invention provides a liquid measuring method which precisely detects a surplus status of a liquid fuel in a fuel cell so as to prevent electrodes from being corroded by the liquid fuel.

Other objects and advantages of the present invention may be further illustrated by the technical features broadly embodied and described as follows.

In order to achieve one or a portion of or all of the objects or other objects, one embodiment of the present invention provides a liquid measurement system for detecting a surplus status of a liquid fuel in a fuel cell. The liquid measurement system includes a storage device, two electrodes, a charging and discharging circuit and a processing unit. The storage device has a containing space for storing the liquid fuel. The two electrodes are oppositely disposed on an outer surface of the storage device to form a capacitor, and the containing space is disposed between the two electrodes. The charging and discharging circuit is electrically connected with the two electrodes and cyclically charges and discharges the capacitor between a first voltage and a second voltage to generate an output signal. The processing unit is electrically connected with the charging and discharging circuit to obtain a wave number of the output signal within a specific time interval, and determines the surplus status of the liquid fuel in the containing space according to the wave number of the output signal within the specific time interval.

An embodiment of the present invention provides a liquid measuring method for detecting a surplus status of a liquid fuel in a fuel cell. The fuel cell includes a storage device and two electrodes. The storage device has a containing space for storing the liquid fuel, and the two electrodes are oppositely disposed on the outer surface of the storage device to form a capacitor. The liquid measuring method includes the following steps: cyclically charging and discharging the capacitor between a first voltage and a second voltage to generate an output signal; obtaining a wave number of the output signal within a specific time interval; and determining the surplus status of the liquid fuel in the containing space according to the wave number, the number of times of first charging and discharging cycles of the capacitor, and the number of times of second charging and discharging cycles of the capacitor.

The above-mentioned embodiment or embodiments of the present invention may have at least one of the following advantages, the electrodes are disposed on the outer surface of the storage device to form a capacitor so that the corrosion of the electrodes caused by the liquid fuel is avoided and that the malfunction of the fuel cell resulting from the electrodes polluting the liquid fuel is prevented. Besides, the liquid measurement system counts the number of times of charging and discharging cycles of the capacitor so as to determine the surplus status of the liquid fuel in the containing space.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a liquid measurement system according to an embodiment of the present invention.

FIG. 2 is a circuit diagram of a charging and discharging circuit shown in FIG. 1.

FIG. 3A is a diagram illustrating a relationship between time and voltage signal when a capacitor is charged and discharged cyclically.

FIG. 3B is a timing diagram of a pulse signal of the processing unit for charging and discharging a capacitor.

FIG. 4 is a schematic diagram of a liquid measurement system according to another embodiment of the present invention.

FIG. 5 is a flowchart of a liquid measuring method according to an embodiment of the present invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

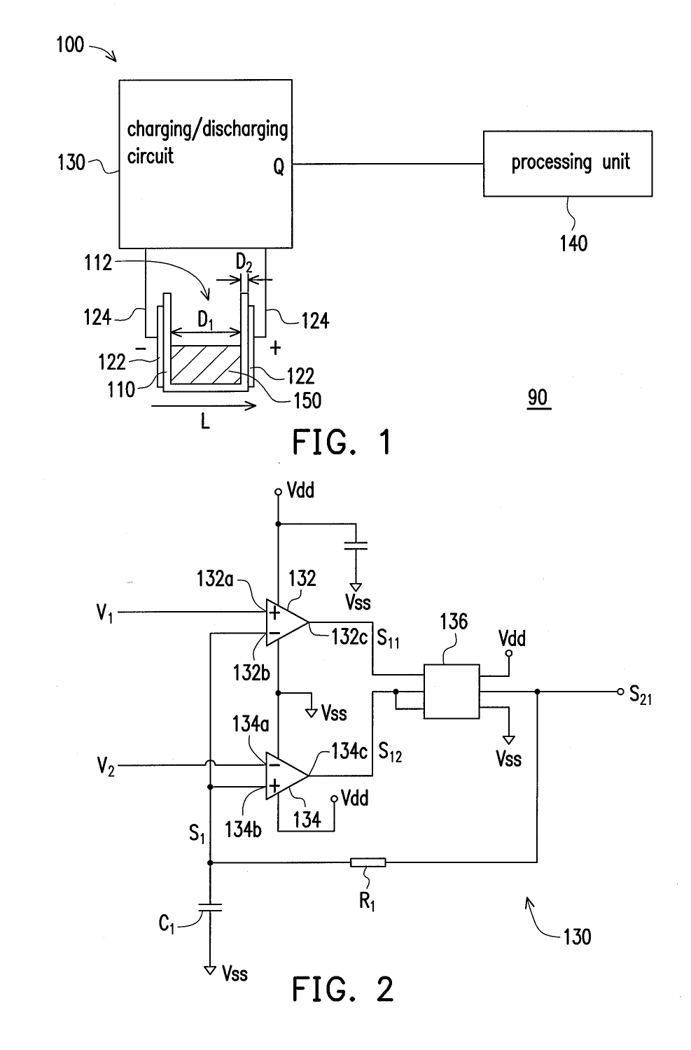

FIG. 1 is a schematic diagram of a liquid measurement system 100 according to an embodiment of the present invention. FIG. 2 is a circuit diagram of a charging and discharging circuit 130 illustrated in FIG. 1, wherein the liquid measurement system 100 is used to detect a surplus status of a liquid fuel 150 in a fuel cell 90. Referring to both FIG. 1 and FIG. 2, the embodiment of the liquid measurement system 100 includes a storage device 110, two electrodes 122, a charging and discharging circuit 130, and a processing unit 140. The storage device 110 has a containing space 112, which is used to store the liquid fuel 150. In the embodiment, the two electrodes 122 are metallic plates. However, the present invention is not limited thereof, and the electrodes 122 may be made of any other conductive material. Two electrodes 122 are oppositely disposed on the outer surface of the storage device 110 to form a capacitor, which is the capacitor C₁ as shown in FIG. 2. The containing space 112 is disposed between the two electrodes 122. The containing space 112 has a gap D₁ along an opposing direction L of the two electrodes 122. In an embodiment of the present invention, a ratio of dividing the gap D₁ by a wall thickness of the storage device D₂ is greater than or equal to 20. In the embodiment, the liquid measurement system 100 further includes two wires 124 to electrically connect the two electrodes 122 with the charging and discharging circuit 130 as shown in FIG. 1.

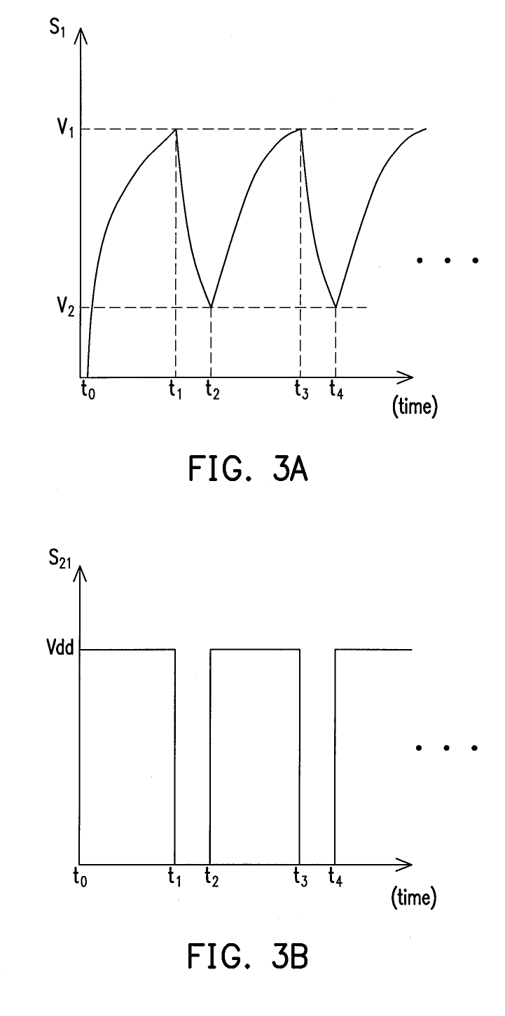

Referring to FIGS. 1 to 3A, the charging and discharging circuit 130 is electrically connected the two electrodes 122 via the wires 124, and the charging and discharging circuit 130 cyclically charges and discharges the capacitor C₁ between a first voltage V₁ and a second voltage V₂ to generate an output signal S₁. Besides, the first voltage V₁ is greater than the second voltage V₂, and a waveform of the output signal S₁ is as shown in FIG. 3A.

In the embodiment, the charging and discharging circuit 130 includes a first comparator 132, a second comparator 134, and a calculating unit 136. The first comparator 132 has a first input terminal 132a, a second input terminal 132b, and a first output terminal 132c. The first input terminal 132a receives the first voltage V₁, and the second input terminal 132b receives the output signal S₁. The first comparator 132 compares the first voltage V₁ and a voltage of the output signal S₁ so that the first output terminal 132c outputs a first comparison signal S₁₁. When the voltage of the output signal S₁ is greater than the first voltage V₁, the first comparison signal S₁₁ is at low level. When the voltage of the output signal S₁ is smaller than the first voltage V₁, the first comparison signal S₁₁ is at high level. In addition, the second comparator 134 has a third input terminal 134a, a fourth input terminal 134b, and a second output terminal 134c. The third input terminal 134a receives the second voltage V₂, and the fourth input terminal 134b receives the output signal S₁. The second comparator 134 compares the second voltage V₂ with the voltage of the output signal S₁ so that the second output terminal 132c outputs a second comparison signal S₁₂. When the voltage of the output signal S₁ is smaller than the second voltage V₂, the second comparison signal S₁₂ is at low level. When the voltage of the output signal S₁ is greater than the second voltage V₂, the second comparison signal S₁₂ is at high level.

In the embodiment, the calculating unit 136 is an S-R latch, for example. In another embodiment, the calculating unit 136 is a plurality of NAND integrated circuits (ICs), which may compose an equivalent S-R latch. In another embodiment, the calculating unit 136 is a microprocessor and a program, wherein the microprocessor executing the program may be achieved the function of the S-R latch. The calculating unit 136 is electrically connected between the first comparator 132 and the second comparator 134 to receive the first comparison signal S₁₁ and the second comparison signal S₁₂ so as to generate a pulse signal S₂₁ according to the first comparison signal S₁₁ and the second comparison signal S₁₂. The pulse signal S₂₁ is used to charge and discharge the capacitor C₁, and the waveform of the pulse signal S₂₁ is as shown in FIG. 3B.

TABLE 1

| S₁ | S₁₁ | S₁₂ | S₂₁ | C₁ |
|---|---|---|---|---|
| Vₛₛ~V₂ | high level | low level | V_{dd} | charging |
| V₂~V₁ | high level | high level | unchanged | unchanged |
| V₁~V_{dd} | low level | high level | Vₛₛ | discharging |

The relationship among the pulse signal S₂₁, the first comparison signal S₁₁ and the second comparison signal S₁₂ is as shown in the Table 1. When the voltage of the output signal S₁ is smaller than the second voltage V₂, the first comparison signal S₁₁ is at high level and the second comparison signal S₁₂ is at low level so that a voltage of the pulse signal S₂₁ is equal to a first system voltage V_{dd}. Hence, the capacitor C₁ is charged. The first system voltage V_{dd} is greater than the first voltage V₁. When the voltage of the output signal S₁ is greater than the first voltage V₁, the first comparison signal S₁₁ is at low level and the second comparison signal S₁₂ is at high level so that the voltage of the pulse signal S₂₁ is equal to a second system voltage Vₛₛ. Hence, the capacitor C₁ is discharged. The above-mentioned second system voltage Vₛₛ is smaller than the first system voltage V_{dd}, and the second system voltage Vₛₛ is generally 0 volt. When the voltage of the output signal S₁ is between the first voltage V₁ and the second voltage V₂, the first comparison signal S₁₁ and the second comparison signal S₁₂ are at high level so that the voltage of the pulse signal S₂₁ is maintained. Hence, the state of charging or discharging of the capacitor is unchanged.

Detail descriptions of the operation that the charging and discharging circuit 130 charges and discharges the capacitor C₁ are provided hereinafter. Referring to FIG. 2, FIG. 3A and FIG. 3B, when the charging and discharging circuit 130 charges and discharges the capacitor C₁, the voltage of the output signal S₁ is raised to the first voltage V₁, for example, within the period t₀ to t₁ or period t₂ to t₃. When the voltage of the output signal S₁ is raised to the first voltage V₁, the voltage of the pulse signal S₂₁ is equal to the first system voltage V_{dd} so that the capacitor C₁ is charged. In detail, when the voltage of the output signal S₁ exceeds over the first voltages V₁ due to charging of the capacitor C₁, the voltage of the pulse signal S₂₁ output by the calculating unit 136 is switched from the first system voltage V_{dd} to the second system voltage Vₛₛ. Hence, the state of the capacitor C₁ is changed from the charging state to the discharging state, such that the voltage of the output signal S₁ is decreased, for example, within the period t₁ to t₂ or the period t₃ to t₄ as shown in FIG. 3A. When the voltage of the output signal S₁ is lower than the second voltages V₂ due to discharging of the capacitor C₁, the voltage of the pulse signal S₂₁ output by the calculating unit 136 is switched from the second system voltage Vₛₛ to the first system voltage V_{dd}. Hence, the state of the capacitor C₁ is changed from the discharging state to the charging state so that the voltage of the output signal S₁ is raised, for example, within the period t₂ to t₃ as shown in FIG. 3A. As a result, by using the first comparator 132 and the second comparator 134, the capacitor C₁ may be cyclically charged and discharged between the first voltage V₁ and the second voltage V₂. The greater the capacitance of the capacitor C₁ is, the longer period the charging and discharging circuit 130 charges and discharges the capacitor C₁, such that the charging and discharging frequency is smaller.

Furthermore, the surplus status of the liquid fuel 150 in the containing space 112 causes different capacitances of the capacitor C₁, such that the charging and discharging wave number of the pulse signal S₂₁ within the specific time interval is various when the capacitor C₁ is cyclically charged and discharged. Hence, the surplus status of the liquid fuel 150 may be determined according to the wave number of the pulse signal S₂₁ within the specific time interval.

In the embodiment, the processing unit 140 is a microprocessor, for example. Since the liquid measurement system of an embodiment of the present invention includes the charging and discharging circuit 130, various kinds of microprocessors, e.g. an AVR microprocessor or an 8051 microprocessor, may be used, such that designs of the embodiments of the present invention may be more flexible. In another embodiment, the charging and discharging circuit 130 may be replaced with microprocessors with product models PIC16F887, PIC16F690 and PIC16F616 of Microchip Technology Inc. However, the disadvantage of using the microprocessors with product models PIC16F887, PIC16F690 and PIC16F616 of Microchip Technology Inc. is that designs of the embodiment of the present is less flexible. The processing unit 140 is electrically connected with the charging and discharging circuit 130 to receive the pulse signal S₂₁, and counts the wave number of the pulse signal S₂₁ within the specific time interval so as to determine the surplus status of the liquid fuel 150 in the containing space 112 according to the counted wave number of the pulse signal S₂₁. Since the wave number of the pulse signal S₂₁ within the specific time interval is equal to the output signal S₁ within the specific time interval, the process of counting the wave number of the output signal S₁ within the specific time interval may be accomplished by counting the wave number of the pulse signal S₂₁ within the specific time interval. In another embodiment of the present invention, the processing unit 140 receives the output signal S₁ and directly counts the wave number of the output signal S₁ within the specific time interval, such that the surplus status of the liquid fuel 150 in the containing space 112 is determined according to the counted wave number of the output signal S₁.

In addition, as shown in FIG. 2, the liquid measurement system 100 further includes a resistor R₁, which is electrically connected between the calculating unit 136 and the capacitor C₁. The resistor R₁ is used to prevent an output terminal of the calculating unit 136 from directly electrically connecting with the capacitor C₁ so that the capacitor C₁ may be cyclically charged and discharged.

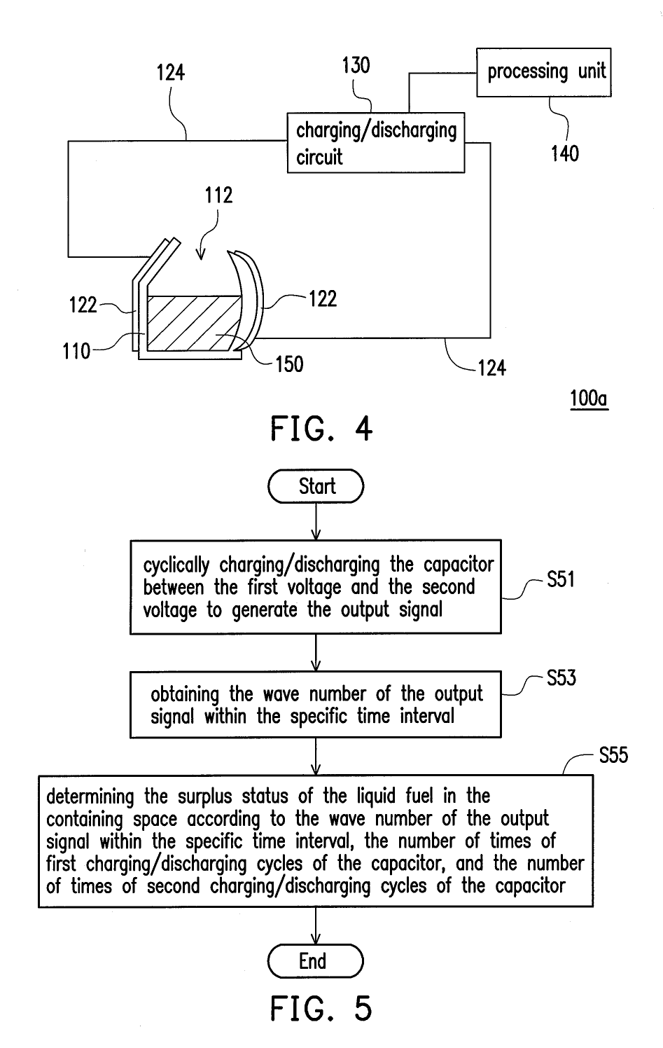

In another embodiment, the two wires 124 of a liquid measurement system 100a are disposed unparallel to each other, as shown in FIG. 4. Hence, a parasitic capacitance between the two wires 124 is efficiently reduced so that the sensitivity of the liquid measurement system 100a is enhanced. Moreover, as shown in FIG. 4, the two electrodes 122 are asymmetric structures, which do not influence the accuracy of the liquid measurement system 100a to determine the surplus status of the liquid fuel 150.

Based on the above, the two electrodes 122 are disposed on the outer surface of the storage device 110 to form the capacitor C₁ in the liquid measurement systems 100 or 100a. Since the two electrodes 122 are disposed on the outer surface of the storage device 110, the corrosion of the electrodes 122 caused by the liquid fuel 150 is prevented and the malfunction of the fuel cell resulting from the electrodes 122 polluting the liquid fuel 150 is avoided.

Furthermore, the amount of the liquid fuel 150 in the storage device 110 causes difference of the capacitance of the capacitor C₁, and the difference of the capacitance of the capacitor C₁ correspond to different charging and discharging periods. As a result, the wave number of the output signal S₁ or the wave number of the pulse signal S₂₁ within the specific time interval corresponds to the present capacitance of the capacitor C₁. In other words, the liquid measurement systems 100 and 100a may determine the surplus status of the liquid fuel 150 according to the wave number of the output signal S₁ or the wave number of the pulse signal S₂₁ within the specific time interval.

Accordingly, an embodiment of the present invention provides a liquid measuring method for detecting a surplus status of liquid fuel in a fuel cell. FIG. 5 is a flowchart of a liquid measuring method according to the embodiment of the present invention. Referring to FIG. 1, the fuel cell 90 includes the storage device 110 and the two electrodes 122. The storage device 110 has the containing space 112 for storing the liquid fuel 150, and the two electrodes 122 are oppositely disposed on the outer surface of the storage device 110 to form the capacitor C₁. In step S51, the capacitor C₁ is cyclically charged and discharged between the first voltage V₁ and the second voltage V₂ so that the output signal S₁ is generated. The processes for cyclically charging and discharging the capacitor C₁ may be found in the previous descriptions. In step S53, the wave number of the output signal S₁ or of the pulse signal S₂₁ within the specific time interval is counted, for example, by using the processing unit 140. Next, in step of S55, the surplus status of the liquid fuel 150 in the containing space 112 is determined according to the counted wave number, the number of times of first charging and discharging cycles of the capacitor C₁, and the number of times of second charging and discharging cycles of the capacitor C₁. The number of times of the first charging and discharging cycles of the capacitor C₁ is the number of times of the capacitor being cyclically charged and discharged between the first voltage V₁ and the second voltage V₂ within the specific time interval when no liquid fuel 150 is in the containing space 112. The number of times of the second charging and discharging cycles of the capacitor C₁ is the number of times of the capacitor being cyclically charged and discharged between the first voltage V₁ and the second voltage V₂ within the specific time interval when the containing space 112 is filled with the liquid fuel 150.

In the embodiment, the surplus status of the liquid fuel 150 in the containing space 112 is determined according to a liquid measure equation. The liquid measure equation is x=k(rₓ)*rₓ*100%, wherein the x is a percentage of the liquid fuel 150 occupying in the containing space 112, the k(rₓ) is a correction coefficient, and the rₓ=(N₀/Nₓ−1)/(N₀/N_{F}−1). The N₀, the N_{F}, the Nₓ are respectively the number of times of the first charging and discharging cycles, the number of times of the second charging and discharging cycles, and the wave number of the output signal S₁ (or the wave number of the pulse signal S₂₁) within the specific time interval.

In details, since uniformity of the material of the storage device 110, consistency of the gap D₁ between the two electrodes 122, and a percentage of air occupying in the containing space all affect the linearity of the measured results of the liquid measurement system 100, the correction coefficient the k(rₓ) in the liquid measure equation may be further a linearity correction coefficient, such that the precisely surplus status of the liquid fuel 150 in the containing space is obtained. Besides, a range of the linearity correction coefficient is between 0.8 and 1. In general, the k(rₓ) is substantially 0.8 as the rₓ is 0.2; the k(rₓ) is substantially 0.9 as the rₓ is 0.6; and the k(rₓ) is substantially 1 as the rₓ is 1.

In summary, the above-mentioned embodiment or embodiments of the present invention may have at least one of the following advantages. The electrodes are disposed on the outer surface of the storage device to form the capacitor so that the corrosion of the electrodes caused by the liquid fuel is prevented and the malfunction of the fuel cell resulting from the electrodes polluting the liquid fuel is avoided. Moreover, the amount of the liquid fuel in the fuel cell causes differences of the capacitance of the capacitor so that the number of times of the charging and discharging cycles of the capacitor within the specific time interval is different. Hence, the surplus status of the liquid fuel may be determined according to the number of times of the charging and discharging cycles of the capacitor within the specific time interval.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A liquid measurement system for detecting a surplus status of a liquid fuel in a fuel cell, the liquid measurement system comprising:
a storage device having a containing space for storing the liquid fuel;
two electrodes oppositely disposed on an outer surface of the storage device to form a capacitor, wherein the containing space is disposed between the two electrodes;
a charging and discharging circuit electrically connected with the two electrodes, the charging and discharging circuit cyclically charging and discharging the capacitor between a first voltage and a second voltage to generate an output signal; and
a processing unit electrically connected with the charging and discharging circuit to obtain a wave number of the output signal within a specific time interval, and the processing unit is capable of determining the surplus status of the liquid fuel in the containing space according to the wave number of the output signal within the specific time interval.

2. The liquid measurement system of claim 1, wherein the processing unit is capable of obtaining the wave number by counting the waves of the output signal within the specific time interval.

3. The liquid measurement system of claim 1, wherein the containing space has a gap along an opposing direction of the two electrodes, and a ratio of dividing the gap by a wall thickness of the storage device is greater than or equal to 20.

4. The liquid measurement system of claim 1, further comprising two wires for electrically connecting the two electrodes with the charging and discharging circuit.

5. The liquid measurement system of claim 4, wherein the two wires are disposed unparallel to each other.

6. The liquid measurement system of claim 1, wherein the charging and discharging circuit comprises:
a first comparator having a first input terminal, a second input terminal, and a first output terminal, wherein the first input terminal is capable of receiving the first voltage, the second input terminal is capable of receiving the output signal, and the first output terminal is capable of generating a first comparison signal;
a second comparator having a third input terminal, a fourth input terminal, and a second output terminal, wherein the third input terminal is capable of receiving the second voltage, the fourth input terminal is capable of receiving the output signal, and the second output terminal is capable of generating a second comparison signal; and
a calculating unit electrically connected with the first comparator and the second comparator to receive the first comparison signal and the second comparison signal so as to generate a pulse signal.

7. The liquid measurement system of claim 6, wherein the processing unit is electrically connected with the calculating unit and is capable of counting the wave number of the pulse signal within the specific time interval.

8. The liquid measurement system of claim 6, further comprising a resistor electrically connected between the calculating unit and the capacitor.

9. The liquid measurement system of claim 6, wherein the calculating unit is an S-R latch.

10. The liquid measurement system of claim 1, wherein the first voltage is greater than the second voltage.

11. The liquid measurement system of claim 1, wherein the two electrodes are asymmetric structures.

12. A liquid measuring method for detecting a surplus status of a liquid fuel in a fuel cell, the fuel cell having a storage device and two electrodes, the storage device having a containing space for storing the liquid fuel, and the two electrodes being oppositely disposed on an outer surface of the storage device to form a capacitor, the liquid measuring method comprising:
cyclically charging and discharging the capacitor between a first voltage and a second voltage to generate an output signal;
obtaining a wave number of the output signal within a specific time interval; and
determining the surplus status of the liquid fuel in the containing space according to the wave number, the number of times of first charging and discharging cycles of the capacitor, and the number of times of second charging and discharging cycles of the capacitor.

13. The liquid measuring method of claim 12, wherein the wave number is obtained by using a processing unit to count the waves of the output signal within the specific time interval.

14. The liquid measuring method of claim 12, wherein the number of times of the first charging and discharging cycles is equal to the number of times of the capacitor being cyclically charged and discharged between the first voltage and the second voltage within the specific time interval when no liquid fuel is in the containing space; and
the number of times of the second charging and discharging cycles is equal to the number of times of the capacitor being cyclically charged and discharged between the first voltage and the second voltage within the specific time interval when the containing space is filled with the liquid fuel.

15. The liquid measuring method of claim 14, wherein the surplus status of the liquid fuel in the containing space is determined according to a liquid measure equation x=k(rₓ)*rₓ*100%, wherein the x is a percentage of the liquid fuel occupying in the containing space, the k(rₓ) is a correction coefficient, and the rₓ=(N₀/Nₓ−1)/(N₀/N_{F}−1), wherein the N₀, the N_{F}, the Nₓ are respectively the number of times of the first charging and discharging cycles, the number of times of the second charging and discharging cycles, and the wave number.

16. The liquid measuring method of claim 15, wherein the k(rₓ) is a linearity correction coefficient, and a range of the linearity correction coefficient is between 0.8 and 1.

17. The liquid measuring method of claim 15, wherein the k(rₓ) is substantially 0.8 as the rₓ is 0.2, the k(rₓ) is substantially 0.9 as the rₓ is 0.6, and the k(rₓ) is substantially 1 as the rₓ is 1.

18. The liquid measuring method of claim 12, wherein the containing space has a gap along an opposing direction of the two electrodes, and a ratio of dividing the gap by a wall thickness of the storage device is greater than or equal to 20.

19. The liquid measuring method of claim 12, wherein a charging and discharging circuit is used to charge and discharge the capacitor, the two electrodes are electrically connected with the charging and discharging circuit via two wires, and the liquid measuring method further comprises placing the two wires to be unparallel to each other.

20. The liquid measuring method of claim 12, wherein the two electrodes are asymmetric structures.
